(19) United States
(12) Patent Application Publication
(10) Pub. No.: US 2015/0066906 A1
(43) Pub. Date: Mar. 5, 2015

(54) METHOD AND SYSTEM FOR PROVIDING LOCATION-BASED SERVICE USING A SERVER DATABASE

(71) Applicant: InfStory Inc., Newark, DE (US)

(72) Inventor: Yin-Hao Chen, Kaohsiung City (TW)

(73) Assignee: InfStory Inc., Newark, DE (US)

(21) Appl. No.: 14/190,163

(22) Filed: Feb. 26, 2014

(30) Foreign Application Priority Data
Aug. 30, 2013 (TW) 102131253

(51) Int. Cl. G06F 17/30

(52) U.S. Cl. CPC G06F 17/30241
USPC 707/722

(57) ABSTRACT

A method for providing location-based service includes the steps of: during browsing of a multimedia file stored in a client device, issuing, using the client device, a database query to a data server to inquire whether the data server stores a place name corresponding to geographic location information of the multimedia file; transmitting, using the data server, the place name to the client device for subsequent display thereon; transmitting, using the data server, a prompt to the client device for prompting input of a new place name; and transmitting, using the client device, the new place name and the geographic location information to the data server for addition into the server database.

### CROSS-REFERENCE TO RELATED APPLICATION

This application claims priority of Taiwanese Patent Application No. 102131253, filed on Aug. 30, 2013.

### BACKGROUND OF THE INVENTION

1. Field of the Invention

The present invention relates to a method and a system for providing location-based service, more particularly to a method and a system for providing location-based service using a server database.

2. Description of the Related Art

Owing to the rapid development of software and hardware associated with information technology, masses of multimedia files are thus generated and may be accessed with ease. For example, a smart phone or a tablet computer provided with an image capturing function and/or a video/audio recording function may be utilized easily to capture images and/or record videos and audios.

Due to generation of great numbers of multimedia files, how to sort masses of multimedia files has become an urgent issue that needs to be addressed. A common sorting method is to categorize the multimedia files according to key words. For example, a place name, such as Tamsui or Jiufen, may be utilized to categorize the multimedia files based on the place name for subsequent storage. Further, parts of the multimedia files belonging to the same category are processed to serve as web page contents, such that multimedia files associated with a specific place name may be readily browsed and shared.

However, it takes significant time and effort to manually categorize masses of multimedia files. Fortunately, an electronic device with positioning functionality has become more common in the market. When the electronic device having positioning functionality is used to capture images, to record videos/audios or to edit text, geographic location information, such as latitude and longitude information, of the electronic device is recorded in the aforementioned multimedia files. In this way, location-based service may thus be provided, and the multimedia files may be automatically sorted based on a place name.

### SUMMARY OF THE INVENTION

Therefore, an object of the present invention is to provide a method for providing location-based service using a server database.

Accordingly, the method of the present invention is to be implemented by a system which includes a client electronic device that stores a multimedia file containing geographic location information, and a data server that includes a server database. The method comprises the steps of:

(A) during browsing of the multimedia file using the client electronic device, issuing, using the client electronic device, a database query to the data server to inquire whether the server database stores a place name corresponding to the geographic location information of the multimedia file;

(B) when a result of the database query is affirmative, transmitting, using the data server, the place name corresponding to the geographic location information of the multimedia file to the client electronic device for subsequent display of the place name on the client electronic device;

(C) when the result of the database query is negative, transmitting, using the data server, a prompt to the client electronic device for prompting input of a new place name corresponding to the geographic location information of the multimedia file; and

(D) in response to the input of the new place name, transmitting, using the client electronic device, the new place name and the geographic location information of the multimedia file to the data server for addition into the server database.

Moreover, another object of the present invention is to provide a system for providing location-based service using a server database.

Accordingly, the system of the present invention comprises a client electronic device, and a data server. The client electronic device stores a multimedia file containing geographic location information. The data server includes a server database. During browsing of the multimedia file using the client electronic device, the client electronic device is operable to issue a database query to the data server to inquire whether the server database stores a place name corresponding to the geographic location information of the multimedia file. When a result of the database query is affirmative, the data server is operable to transmit the place name corresponding to the geographic location information of the multimedia file to the client electronic device for subsequent display of the place name on the client electronic device. When the result of the database query is negative, the data server is operable to transmit a prompt to the client electronic device for prompting input of a new place name corresponding to the geographic location information of the multimedia file. In response to the input of the new place name, the client electronic device is operable to transmit the new place name and the geographic location information of the multimedia file to the data server for addition into the server database.

An effect of the present invention resides in that, by virtue of arrangement of the client electronic device and the data server and by virtue of the method for providing location-based service, a place name corresponding to the multimedia file may be provided for display, and the geographic location information and a place name corresponding to the geographic location information may be added into the server database of the data server.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a preferred embodiment of a system for providing location-based service using a server database according to the present invention;

FIG. 2 is a flow chart illustrating a data collection procedure of a preferred embodiment of a method for providing location-based service using a server database according to the present invention;

FIG. 3 is a flow chart illustrating a data search procedure of the preferred embodiment of the method for providing location-based service according to the present invention;

FIG. 4 illustrates an operation interface of a client electronic device of the system of the preferred embodiment for input of a key word;

FIG. 5 illustrates an operation interface of the client electronic device for representing multimedia files corresponding to the key word in a dynamic folder;

FIG. 6 illustrates an operation interface for representing a dynamic web page corresponding to the key word; and

FIG. 7 illustrates an operation interface for representing updated contents of the dynamic web page corresponding to the key word.

### DETAILED DESCRIPTION OF THE PREFERRED EMBODIMENT

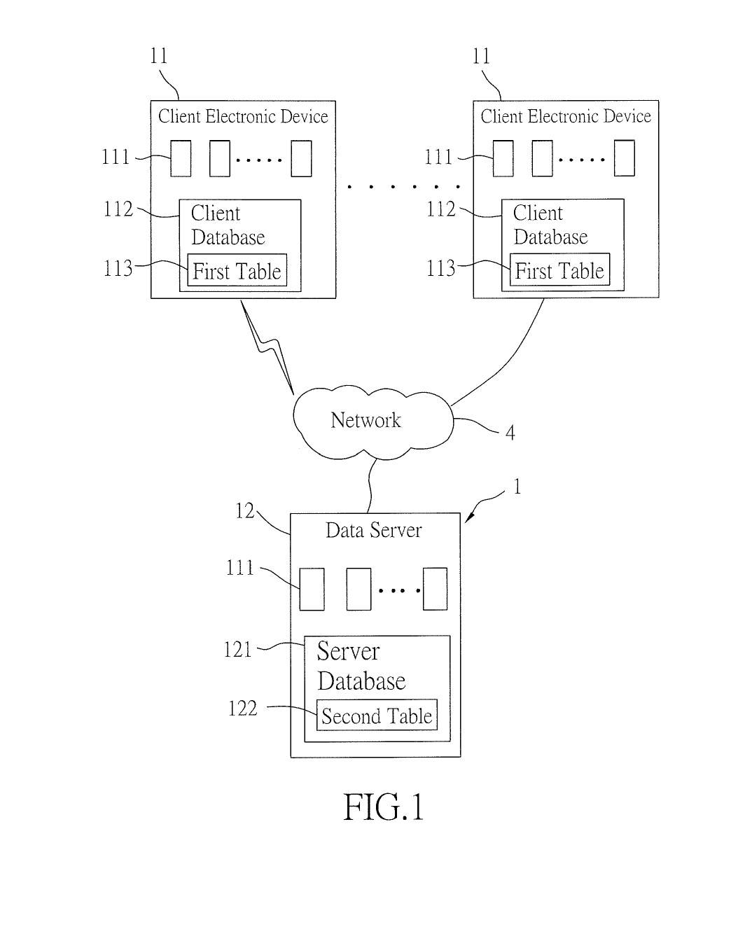

Referring to FIG. 1, a preferred embodiment of a method for providing location-based service using a server database is to be implemented by a system 1 as shown in FIG. 1.

A preferred embodiment of the system 1 according to the present invention includes a plurality of client electronic devices 11 and a data server 12. Each of the client electronic devices 11 stores at least one multimedia file 111 containing geographic location information, and includes a client database 112 storing a first table 113. The data server 12 includes a server database 121 storing a second table 122. The client electronic devices 11 communicate with the data server 12 via a network 4. The multimedia file 111 stored in the client electronic device 11 is selected from an image file, a video file, an audio file, a text file and combinations thereof. The geographic location information contained in the multimedia file 111, for instance, is latitude and longitude information. Each of the first table 113 and the second table 122 includes a column associated with geographic location information, a column associated with place name, and a column associated with file names. These columns are all null in an initial state.

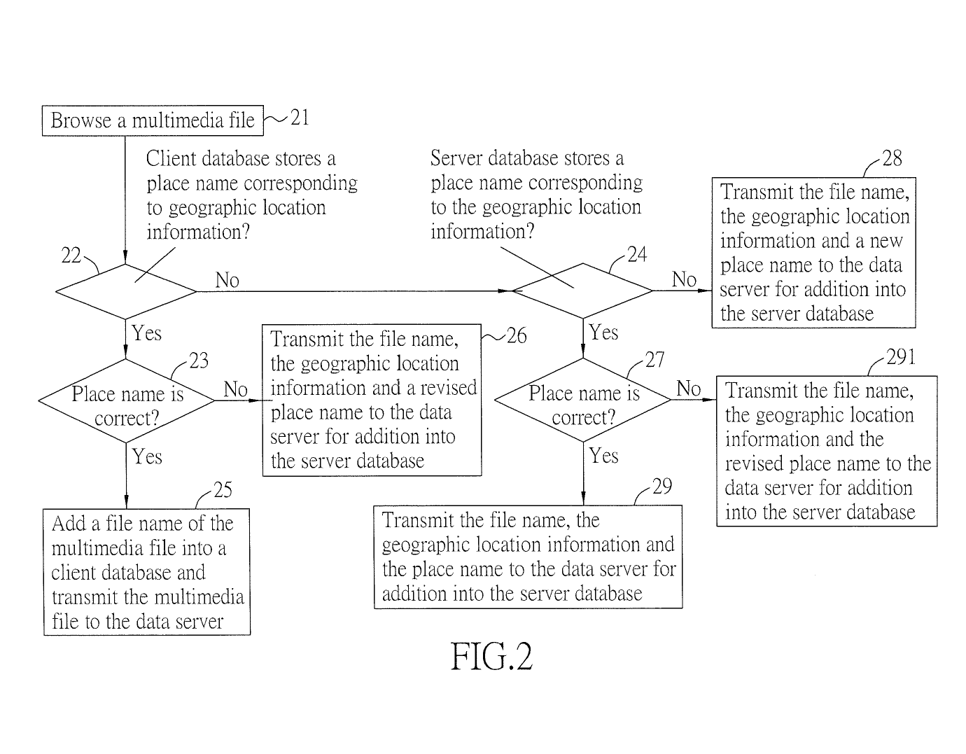

Referring to FIG. 1 to FIG. 3, the preferred embodiment of the method of the present invention includes a data collection procedure 2 and a data search procedure 3. Referring to FIG. 2, the data collection procedure 2 includes the following steps.

In step 21, the client electronic device 11 is used by a user for browsing of the at least one multimedia file 111.

In step 22, during browsing of the at least one multimedia file 111 using the client electronic device 11, the client electronic device 11 is operable to inquire whether the first table 113 of the client database 112 stores a place name corresponding to the geographic location information of the multimedia file 111.

In step 23, when a result of the inquiry made in step 22 is affirmative, the client electronic device 11 is operable to display the place name found in step 22. In this way, the user is able to make confirmation as to whether the place name displayed on the client electronic device 11 is correct.

In step 25, after display of the place name on the client electronic device 11 and the confirmation by the user of the client electronic device 11 that the place name displayed on the client electronic device 11 is correct, the client electronic device 11 is operable to add a file name of the multimedia file 111 into a field of the first table 113 of the client database 112 which corresponds to a field that stores the geographic location information contained in the multimedia file 111 and a field that stores the place name corresponding to the geographic location information. The client electronic device 11 is further operable to transmit the multimedia file 111 to the data server 12 for storage in the data server 12.

In step 26, after display of the place name on the client electronic device 11 and the confirmation by the user of the client electronic device 11 that the place name displayed on the client electronic device 11 is incorrect, the client electronic device 11 is used by the user to input a revised place name. The client electronic device 11 is operable to add the file name of the multimedia file 111, the geographic location information contained in the multimedia file 111, and the revised place name corresponding to the geographic location information of the multimedia file 111 into the first table 113 of the client database 112 of the client electronic device 11. The client electronic device 11 is further operable to transmit the file name of the multimedia file 111, the geographic location information contained in the multimedia file 111, and the revised place name corresponding to the geographic location information of the multimedia file 111 to the data server 12 for addition into the second table 122 of the server database 121 of the data server 12. Further, the client electronic device 11 is operable to transmit the multimedia file 111 to the data server 12 for storage in the data server 12.

In step 24, when a result of the inquiry made in step 22 is negative, the client electronic device 11 is operable to issue a database query to the data server 12 to inquire whether the second table 122 of the server database 121 stores a place name corresponding to the geographic location information of the multimedia file 111.

In step 27, when a result of the database query issued in step 24 is affirmative, the data server 12 is operable to transmit the place name corresponding to the geographic location information of the multimedia file 111 to the client electronic device 11 for subsequent display of the place name on the client electronic device 11. In this way, the user is able to make confirmation as to whether the place name displayed on the client electronic device 11 is correct.

In step 29, after display of the place name on the client electronic device 11 and the confirmation by the user of the client electronic device 11 that the place name displayed on the client electronic device 11 is correct, the client electronic device 11 is operable to add the file name of the multimedia file 111, the geographic location information contained in the multimedia file ill, and the place name corresponding to the geographic location information of the multimedia file 111 into the first table 113 of the client database 112 of the client electronic device 11. The client electronic device 11 is further operable to transmit the file name of the multimedia file 111, the geographic location information contained in the multimedia file 111, and the place name corresponding to the geographic location information of the multimedia file 111 to the data server 121 for addition into the second table 122 of the server database 121 of the data server 12. Further, the client electronic device 11 is operable to transmit the multimedia file 111 to the data server 12 for storage in the data server 12.

In step 291, after display of the place name on the client electronic device 11 and the confirmation by the user of the client electronic device 11 that the place name displayed on the client electronic device 11 is incorrect, the client electronic device 11 is used by the user to input a revised place name. The client electronic device 11 is operable to add a file name of the multimedia file 111, the geographic location information contained in the multimedia file 111, and the revised place name corresponding to the geographic location information of the multimedia file 111 into the first table 113 of the client database 112 of the client electronic device 12. The client electronic device 12 is further operable to transmit the file name of the multimedia file 111, the geographic location information contained in the multimedia file 111, and the revised place name corresponding to the geographic location information of the multimedia file 111 to the data server 12 for addition into the second table 122 of the server database 121 of the data server 12. Further, the client electronic device 11 is operable to transmit the multimedia file 111 to the data server 12 for storage in the data server 12.

In step 28, when the result of the database query issued in step 24 is negative, the data server 12 is operable to transmit a prompt to the client electronic device 11 for prompting input of a new place name corresponding to the geographic location information of the multimedia file 111. In this way, the client electronic device 11 may be used by the user to input the new place name corresponding to the geographic location information. In response to the input of the new place name, the client electronic device 11 is operable to add the file name of the multimedia file 111, the geographic location information contained in the multimedia file 111, and the new place name corresponding to the geographic location information of the multimedia file 111 into the first table 113 of the client database 112 of the client electronic device 11. Moreover, in response to the input of the new place name, the client electronic device 11 is further operable to transmit the file name of the multimedia file 111, the geographic location information of the multimedia file 111, and the new place name corresponding to the geographic location information of the multimedia file 111 to the data server 12 for addition into the second table 122 of the server database 121. Further, the client electronic device 11 is operable to transmit the multimedia file 111 to the data server 12 for storage in the data server 12.

Specifically, an exemplary implementation of step 22, in which the client electronic device 11 inquires whether the first table 113 of the client database 112 stores the place name corresponding to the geographic location information of the multimedia file 111, is provided hereinafter. In this implementation, the geographic location information is represented by the latitude and longitude. A WGS84 ellipsoidal distance between the geographic location information of the multimedia file 111 and each entry of geometric location information stored in the first table 113 of the client database 112 is calculated. When a smallest one of the WGS84 ellipsoidal distances thus calculated is smaller than a predetermined threshold, the first table 113 stores a place name corresponding to the geographic location information of the multimedia file 111. For instance, Table 1 below is given as an example of the first table 113. It is assumed that the geographic location information of the multimedia file 111 is represented by 25.018726 degrees north latitude and 121.943615 degrees east longitude, and the predetermined threshold is 1000 meters. Referring to Table 1, only two entries of geographic location information in the first and second rows satisfy the aforementioned predetermined threshold. Each of the WGS84 ellipsoidal distance between the geographic location information of the multimedia file 111 and a respective one of the two entries of geographic location information in the first and second rows of the Table 1 is 110.118095 meters and 168.612 meters, respectively. Therefore, the place name corresponding to the geographic location information of the multimedia file 111 is a place name in the first row of the Table 1, i.e., Fulong. Similarly, in step 24, the aforementioned process may be utilized to inquire whether the second table 122 of the server database 121 stores the place name corresponding to the geographic location information of the multimedia file 111.

TABLE 1

| | Geographic Location | | |
|---|---|---|---|
| | Information | Place Name | File Name |
| 1^{st} row | 25.019277° N, | Fulong | XX |
| | 121.944527° E | | |
| 2^{nd} row | 25.017212° N, | Fulong | YY |
| | 121.943784° E | | |
| 3^{rd} row | 21.931959° N, | Kenting | AA |
| | 120.824936° E | | |
| 4^{th} row | 22.002438° N, | Kenting | BB |
| | 120.743289° E | | |
| 5^{th} row | NULL | NULL | NULL |
| 6^{th} row | NULL | NULL | NULL |

It is noted that even though the server database 121 in the initial state does not store place names such that the user is frequently prompted to input anew place name in an early operation stage of the system 1, the server database 121 may store plenty of place names for supporting the location-based service after the data collection procedure 2 has been executed for a period of time by the different client electronic devices 11 which are consistently operated by different users.

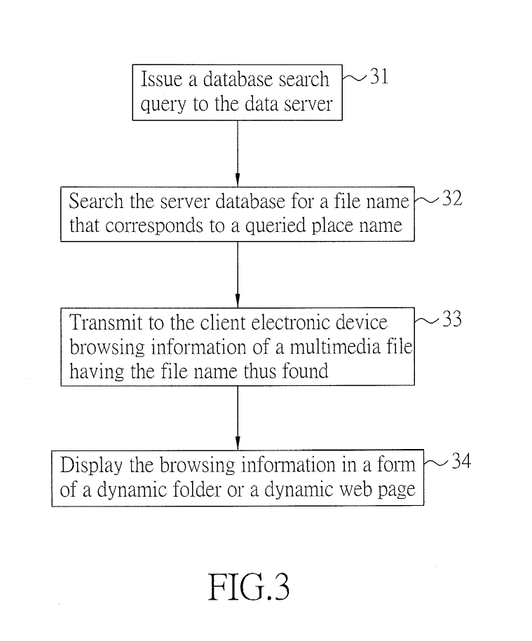

Referring to FIG. 3, the data search procedure 3 includes the following steps.

In step 31, the client electronic device 11 is used by the user for issuing a database search query associated with a search for a queried place name to the data server 12.

In step 32, in response to receipt by the data server 12 of the database search query associated with the search for the queried place name and received from the client electronic device 11, the data server 12 is operable to search the second table 122 of the server database 121 for at least one file name that corresponds to the queried place name.

In step 33, the data server 12 is operable to transmit to the client electronic device 11 browsing information of at least one multimedia file 111 that is stored in the data server 12 and that has the file name found in step 32.

In step 34, the client electronic device 11 is operable to display the browsing information of the at least one multimedia file 111 transmitted by and received from the data server 12 in a form of a dynamic folder or a dynamic web page, i.e., a server dynamic folder or a server dynamic web page.

Moreover, in a configuration of an embodiment of the data search procedure 3, aside from performing the aforementioned steps 31 to 34, the client electronic device 11 is further operable to search the first table 113 of the client database 112 for at least one file name that corresponds to the queried place name. Subsequently, the client electronic device 11 generates a client dynamic folder or a client dynamic web page for representing browsing information of at least one multimedia file 111 that is stored in the client electronic device 11 and that has the file name found thereby. The client electronic device 11 may be operated by the user to switch between the client dynamic folder, the client dynamic web page, the server dynamic folder and the server dynamic web page for browsing.

Referring to Table 2, the first table 113 of the client database 112 and the second table 122 of the server database 121 may be implemented as exemplified in Table 2. That is to say, the first and second table 113 and 122 may further include a column associated with titles and a column associated with text contents. In this way, in step 28 of the data collection procedure 2, the prompt transmitted by the data server 12 to the client electronic device 11 is further adapted for prompting input of a new title and new text contents, such that aside from input of the new place name corresponding to the geographic location information of the multimedia file 111, the client electronic device 11 may be further used by the user for input of the new title and new text contents. Accordingly, when performing the data search procedure 3, data which are stored in the columns associated with the place names, the titles and the text contents may be inspected and compared with a key word, such that the key word is not limited to the queried place name. The user is able to utilize the client electronic device 11 to browse an identical multimedia file that is associated with more than one key word and that is stored in the data server 12 or the client electronic device 11. For example, both “Fulong” and “music festival” may serve as key words for searching for the multimedia file 111 that has the file name of “XX”.

TABLE 2

| | Geographic | | | | |
|---|---|---|---|---|---|
| | Location | Place | File | | |
| | Information | Name | Name | Title | Text Contents |
| 1^{st} row | 25.019277° N, | Fulong | XX | Fulong | Bands perform |
| | 121.944527° E | | | 2013 | excellent |
| | | | | music | |
| | | | | festival | |
| 2^{nd} row | 25.017212° N, | Fulong | YY | Fulong | Sunset with |
| | 121.943784° E | | | sunset | family |
| | | | | | (2013/07/01) |
| 3^{rd} row | 21.931959° N, | Kenting | AA | South | Beautiful |
| | 120.824936° E | | | Taiwan | beach |
| | | | | touring | |
| 4^{th} row | 22.002438° N, | Kenting | BB | Cape | Aga's House |
| | 120.743289° E | | | No. 7 | |
| 5^{th} row | NULL | NULL | NULL | NULL | NULL |
| 6^{th} row | NULL | NULL | NULL | NULL | NULL |

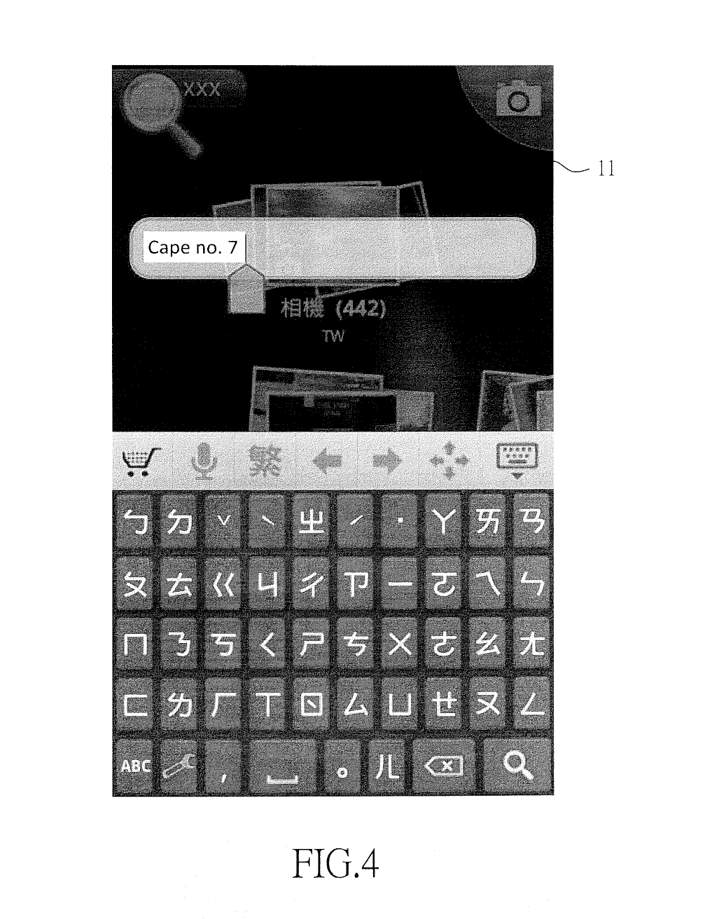

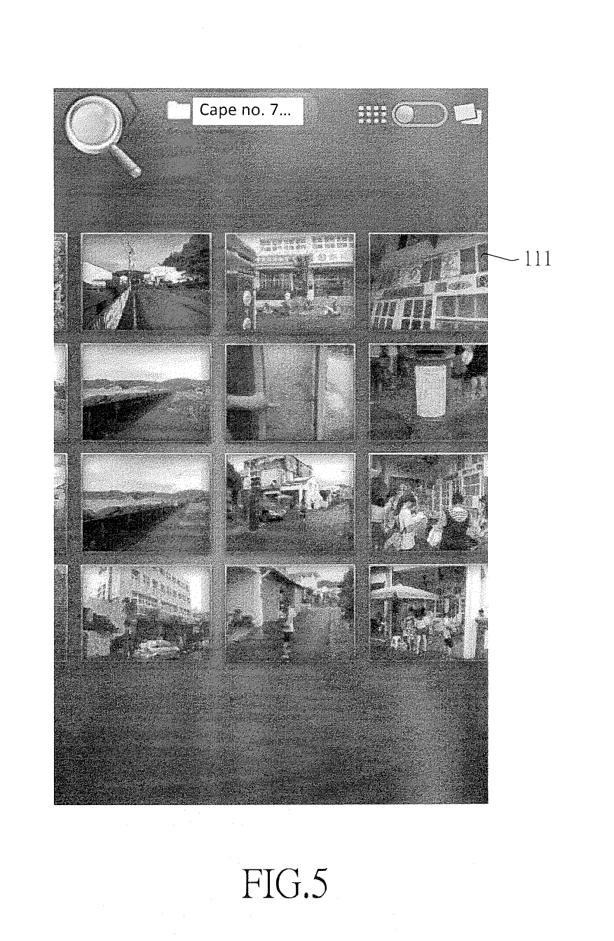

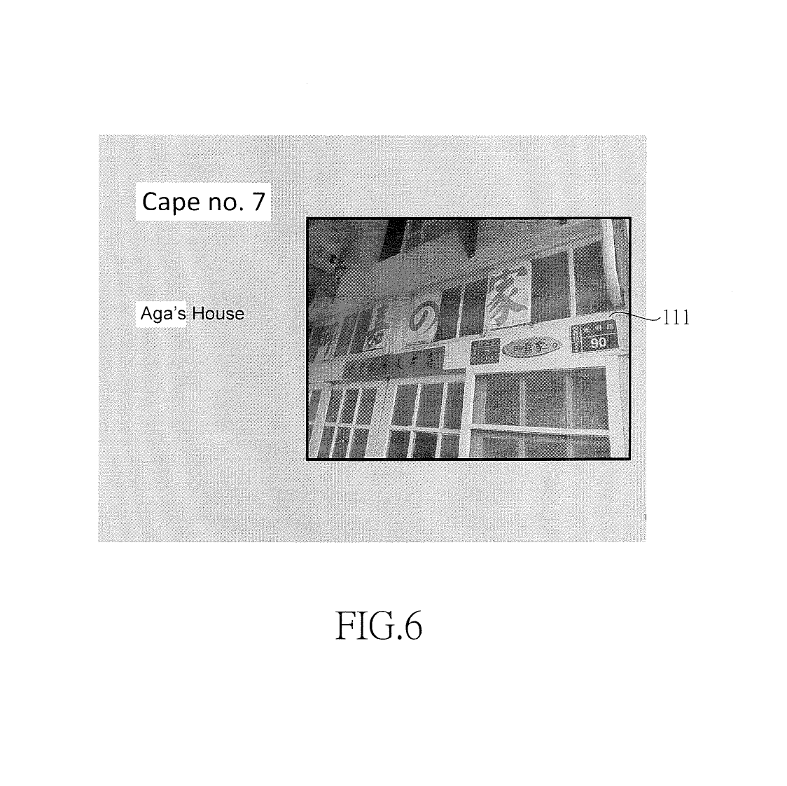

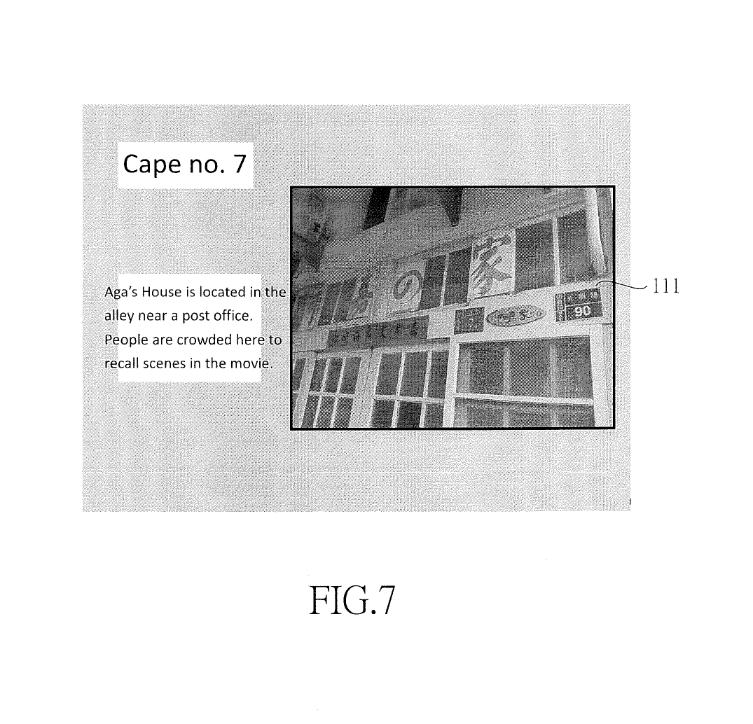

Specifically, contents in the server dynamic folder or the server dynamic web page are automatically updated by the data server 12 according to data updates in the server database 121 and increased numbers of multimedia files in the data server 12. Furthermore, an identical key word used for search at different time points may result in different server dynamic folders or server dynamic web pages. For example, referring to FIG. 4, a key word “Cape no. 7” (a movie name) is inputted via the client electronic device 11 for search at a first time point. Subsequently, a server dynamic folder representing a plurality of multimedia files 111 is generated as shown in FIG. 5, and a server dynamic web page representing one of the multimedia files 111 is generated as shown in FIG. 6. The server dynamic web page contains an image file 111, a title “cape no. 7” corresponding to the image file 111, and text contents “Aga's House” (a movie landmark) corresponding to the image file 111. At a second time point, as best shown in FIG. 7, since text contents corresponding to the image file 111 have been revised, a new server web page which contains the image file 111 and new text contents different from “Aga's House” is generated as a result of automatic updates by the data server 12 or as a result of input via the client electronic device 11 of the key word “Cape no. 7” for conducting a new search. Similarly, an identical key word used to search the client database 112 at different time points may result in different client dynamic folders or client dynamic web pages displayed on the client electronic device 11.

To sum up, the method and system for providing location-based service using a server database according to the present invention may enable a plurality of users to jointly establish data in the server database 121, and enable each of the users to singly establish data in the client database 112 of a respective one of the client electronic devices 11. Furthermore, the data search procedure 3 may be used to search the data server 12 or the client electronic device 11 for multimedia data corresponding to the key word, and the multimedia data thus found may be displayed on the client electronic device 11 in a form of the server dynamic folder, the server dynamic web page, the client dynamic folder or the client dynamic web page.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for providing location-based service, the method to be implemented by a system which includes a client electronic device that stores a multimedia file containing geographic location information, and a data server that includes a server database, the method comprising the steps of:
(A) during browsing of the multimedia file using the client electronic device, issuing, using the client electronic device, a database query to the data server to inquire whether the server database stores a place name corresponding to the geographic location information of the multimedia file;
(B) when a result of the database query is affirmative, transmitting, using the data server, the place name corresponding to the geographic location information of the multimedia file to the client electronic device for subsequent display of the place name on the client electronic device;
(C) when the result of the database query is negative, transmitting, using the data server, a prompt to the client electronic device for prompting input of a new place name corresponding to the geographic location information of the multimedia file; and
(D) in response to the input of the new place name, transmitting, using the client electronic device, the new place name and the geographic location information of the multimedia file to the data server for addition into the server database.

2. The method as claimed in claim 1, the client electronic device including a client database, wherein step (B) includes, after display of the place name on the client electronic device and confirmation by a user of the client electronic device that the place name displayed on the client electronic device is correct,
adding, using the client electronic device, a file name of the multimedia file, the geographic location information contained in the multimedia file, and the place name corresponding to the geographic location information of the multimedia file into the client database of the client electronic device,
transmitting, using the client electronic device, the file name of the multimedia file, the geographic location information contained in the multimedia file, and the place name corresponding to the geographic location information of the multimedia file to the data server for addition into the server database of the data server, and
transmitting, using the client electronic device, the multimedia file to the data server for storage in the data server.

3. The method as claimed in claim 1, the client electronic device including a client database, wherein step (B) includes, after display of the place name on the client electronic device and confirmation by a user of the client electronic device that the place name displayed on the client electronic device is incorrect,
inputting, using the client electronic device, a revised place name,
adding, using the client electronic device, a file name of the multimedia file, the geographic location information contained in the multimedia file, and the revised place name corresponding to the geographic location information of the multimedia file into the client database of the client electronic device,
transmitting, using the client electronic device, the file name of the multimedia file, the geographic location information contained in the multimedia file, and the revised place name corresponding to the geographic location information of the multimedia file to the data server for addition into the server database of the data server, and
transmitting, using the client electronic device, the multimedia file to the data server for storage in the data server.

4. The method as claimed in claim 1, wherein, in step (D):
a file name of the multimedia file is further transmitted to the data server using the client electronic device for addition into the server database; and
the multimedia file is further transmitted to the data server using the client electronic device for storage in the data server.

5. The method as claimed in claim 4, further comprising the steps of:
(E) in response to receipt by the data server of a database search query associated with a search for a queried place name and received from the client electronic device, searching, using the data server, the server database for at least one file name that corresponds to the queried place name; and
(F) transmitting to the client electronic device, using the data server, browsing information of at least one multimedia file that is stored in the data server and that has the file name found in step (E).

6. The method as claimed in claim 5, further comprising, after step (F), the step of:
(G) displaying, using the client electronic device, the browsing information transmitted by and received from the data server in a form of a dynamic folder or a dynamic web page.

7. The method as claimed in claim 1, wherein the multimedia file stored in the client electronic device is selected from an image file, a video file, an audio file, a text file and combinations thereof.

8. A system for providing location-based service, said system comprising:
a client electronic device that stores a multimedia file containing geographic location information; and
a data server that includes a server database;
wherein, during browsing of the multimedia file using said client electronic device, said client electronic device is operable to issue a database query to said data server to inquire whether said server database stores a place name corresponding to the geographic location information of the multimedia file;
wherein, when a result of the database query is affirmative, said data server is operable to transmit the place name corresponding to the geographic location information of the multimedia file to said client electronic device for subsequent display of the place name on said client electronic device;
wherein, when the result of the database query is negative, said data server is operable to transmit a prompt to said client electronic device for prompting input of a new place name corresponding to the geographic location information of the multimedia file; and
wherein, in response to the input of the new place name, said client electronic device is operable to transmit the new place name and the geographic location information of the multimedia file to said data server for addition into said server database.

9. The system as claimed in claim 8, wherein said client electronic device includes a client database, and, after display of the place name on said client electronic device and confirmation by a user of said client electronic device that the place name displayed on said client electronic device is correct, said client electronic device is operative to:
add a file name of the multimedia file, the geographic location information contained in the multimedia file, and the place name corresponding to the geographic location information of the multimedia file into said client database of said client electronic device;
transmit the file name of the multimedia file, the geographic location information contained in the multimedia file, and the place name corresponding to the geographic location information of the multimedia file to said data server for addition into said server database of said data server; and
transmit the multimedia file to said data server for storage in said data server.

10. The system as claimed in claim 8, wherein said client electronic device includes a client database, and, after display of the place name on said client electronic device and confirmation by a user of said client electronic device that the place name displayed on said client electronic device is incorrect, said client electronic device is operative to
input a revised place name;
add a file name of the multimedia file, the geographic location information contained in the multimedia file, and the revised place name corresponding to the geographic location information of the multimedia file into said client database of said client electronic device;
transmit the file name of the multimedia file, the geographic location information contained in the multimedia file, and the revised place name corresponding to the geographic location information of the multimedia file to said data server for addition into said server database of said data server; and
transmit the multimedia file to said data server for storage in said data server.

11. The system as claimed in claim 8, wherein said client electronic device is further operable to transmit a file name of the multimedia file to said data server for addition into said server database, and to transmit the multimedia file to said data server for storage in said data server.

12. The system as claimed in claim 11, wherein, in response to receipt by said data server of a database search query associated with a search for a queried place name and received from said client electronic device, said data server is operative to search said server database for at least one file name that corresponds to the queried place name; and
wherein said data server is operable to transmit to said client electronic device browsing information of at least one multimedia file that is stored in said data server and that has the file name found in said server database by said data server.

13. The system as claimed in claim 12, wherein said client electronic device is further operable to display the browsing information transmitted by and received from said data server in a form of a dynamic folder or a dynamic web page.

14. The system as claimed in claim 8, wherein the multimedia file stored in said client electronic device is selected from an image file, a video file, an audio file, a text file and combinations thereof.
